(19) United States
(12) Patent Application Publication
(10) Pub. No.: US 2006/0130634 A1
(43) Pub. Date: Jun. 22, 2006

(54) String stretcher for stringed instruments

(76) Inventor: Alan Campbell Bryson, Houston, TX (US)

Correspondence Address: Alan C. Bryson, 1901 Augusta Dr. #152, Houston, TX, 77057, US

(21) Appl. No.: 11/318,948

(22) Filed: Dec. 27, 2005

Related U.S. Application Data
(63) Continuation-in-part of application No. 10/794,364, filed on Mar. 5, 2004.

(51) Int. Cl. G10G 7/00

(52) U.S. Cl. 84/458

(57) ABSTRACT

According to some embodiments, a string stretcher includes a body. A first member coupled to the body is adapted for contacting a string of a musical instrument at a first contact location. A second member coupled to the body is adapted for contacting the string at a second contact location spaced from the first contact location. The body is configured for rotation by hand such that the first member applies a force to the string in one direction while the second member applies a force to the string in another direction. Some embodiments include wheels for applying opposing lateral forces to the string. The wheels may roll along the string as the string stretcher is translated along the string.

### CROSS-REFERENCE TO RELATED APPLICATION

This application is a continuation-in-part of U.S. patent application Ser. No. 10/794,364, filed Mar. 5, 2004, the entirety of which is incorporated by reference.

### BACKGROUND OF INVENTION

1. Field of the Invention

The invention relates generally to musical instrument accessories. More particularly, the invention relates to a string stretcher for stretching the strings of a stringed instrument.

2. Background Art

A stringed instrument, such as a guitar, typically has multiple strings supported in tension above a fingerboard. For example, FIG. 1 depicts a conventional acoustic guitar 50 having a body 52, a neck 54, and a headstock 56. Six strings 58 are strung from the bridge 60 at one end of the guitar 50, across the fingerboard 62, over the nut 64, and to some tuning pegs 66. The strings 58 are typically supported a short distance above the fingerboard 62, so they are free to vibrate. A number of frets 59 are disposed along the fingerboard 62. A player may play a variety of notes by pressing the strings 58 onto frets 59, and simultaneously plucking the strings 58 with the other hand. Some stringed instruments do not have frets, and the strings may instead be pressed directly onto the fingerboard.

The tuning pegs 66 are typically rotated by hand to adjust string tension. Tuning the guitar generally involves tensioning each string 58 to a desired vibration frequency or “note.” However, strings are commonly made of materials such as steel and nylon that can stretch (i.e. plastically elongate), causing an undesired reduction in string tension. String tension and the increased forces generated in the strings during playing may therefore cause the strings to go out of tune, especially when the strings are new. This may be especially true for lower-gauge strings, such as those frequently used on electric guitars. Thus, it is common practice to pre-stretch a newly-installed set of strings by hand, to make the strings resistant to further elongation and de-tuning.

A common way to stretch a string involves grasping it between the thumb and fingers of each hand, pulling it one direction with one hand and simultaneously pushing it in the opposite direction with the other hand. This “push-pull” motion may be repeated at multiple locations along the string. The hands may be spaced apart a short distance to minimize the lateral displacement of the string with respect to the fingerboard. This is generally better than yanking the string in only one direction across the fingerboard like a bow and arrow, which can cause undesirable consequences like damage to the bridge or nut.

Strings are usually quite thin and can be uncomfortable to handle with force. Although a musician may develop sufficient finger calluses to comfortably play an instrument, it can still be painful and tedious to pre-stretch strings with bare hands. Furthermore, pre-stretching by hand may not fully uniformly stretch the string along its entire length.

A string-stretching device is therefore desirable, to more uniformly and efficiently stretch strings, to prevent the discomfort of stretching by hand, and so forth. Few devices, if any, are available on the market.

### BRIEF SUMMARY OF EMBODIMENTS OF THE INVENTION

According to some embodiments, a string stretcher includes a body. A first member coupled to the body is adapted for contacting a string of a musical instrument at a first contact location. A second member coupled to the body is adapted for contacting the string at a second contact location spaced from the first contact location. The body is configured for rotation by hand such that the first member applies a force to the string in one direction while the second member applies a force to the string in another direction.

According to other embodiments, a method is provided for stretching a string of a stringed instrument. The string is contacted at a first location with a first member coupled to a body. The string is contacted at a second location with a second member coupled to the body. The body is rotated, such that the first member applies a force to the string in one direction while the second member applies a force to the string in another direction.

Other aspects and advantages of the invention will be apparent from the following description and the appended claims.

### BRIEF DESCRIPTION OF DRAWINGS

FIG. 1 shows a conventional acoustic guitar.

FIG. 2 shows an embodiment of a string stretcher having a pair of legs and a centrally positioned lifting member.

FIG. 3 shows an embodiment of a string stretcher having a handle angled at about 30 degrees with respect to a string.

FIG. 4 shows an embodiment of a string stretcher having a prong secured to each leg.

FIG. 5 shows an embodiment of a string stretcher having a pair of pulleys for engaging a string.

FIG. 6 shows one of the pulleys in greater detail.

FIG. 7 shows an embodiment of a string stretcher having a pair of sleeves for engaging a string.

FIG. 8 shows an embodiment of a legless string stretcher.

FIG. 9 shows a flowchart describing a method of stretching strings.

### DETAILED DESCRIPTION OF EMBODIMENTS OF THE INVENTION

One aspect of the invention relates to a device for stretching the strings of an instrument. Another aspect of the invention relates to a method of stretching the strings of an instrument. According to some embodiments, a device is operable by hand to impart lateral forces to a string to stretch the string. More particularly, embodiments of a string stretcher may include a body configured for rotation by hand, such as with a handle. A pair of legs may be supported on the body, each for contacting the string at a different location. When the body is rotated, one leg applies a force to the string in one direction, and the other leg applies a force to the string in an opposing direction. The device may optionally be moved along the length of the string while the body is in a rotated position, to more uniformly stretch the string. Some embodiments include a pair of wheels for applying the lateral forces to the string. The wheels may roll along the string while the device is moved along the string's length.

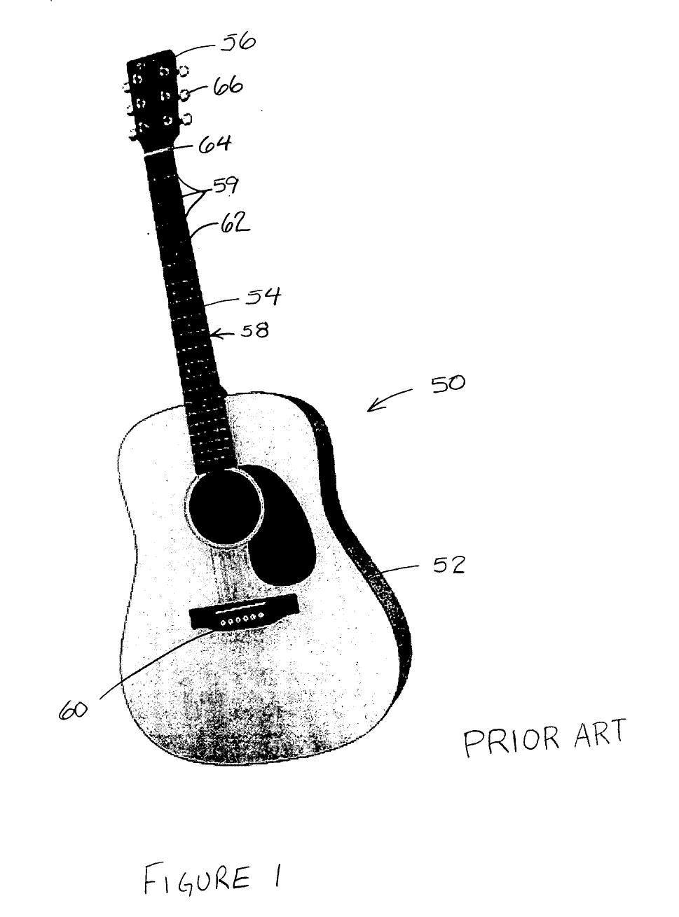

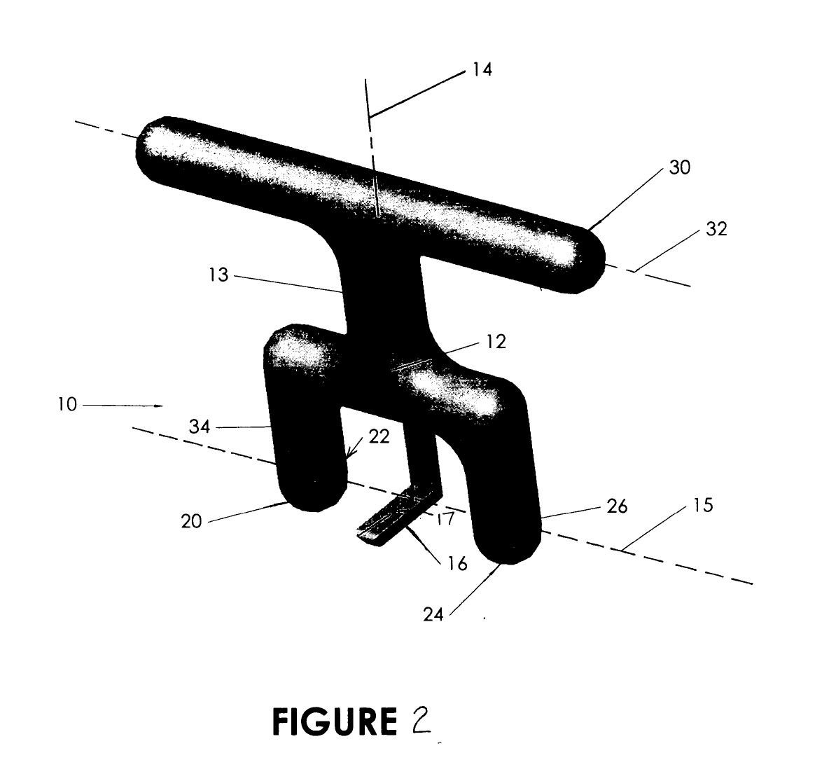

In discussing various embodiments, reference may be made to elements of the exemplary guitar 50 depicted in FIG. 1. FIG. 2 shows one embodiment of a string stretcher 10 for stretching a string depicted by dashed line 15. The string stretcher 10 has a body 12, which may be rotated about an axis 14. The string stretcher 10 may be positioned so that the axis 14 is oriented transversely to the fingerboard 62 (FIG. 1). For purpose of discussion, the axis 14 is assumed to be positioned perpendicular to the fingerboard 62, with the “up” direction being away from the fingerboard 62.

Still referring to FIG. 2, a lifting member 16 is secured to the body 12. The lifting member 16 includes a prong 17. The prong 17 may be inserted below the string 15, and the string stretcher 10 may be lifted to urge the string 15 at least slightly above neighboring strings. A first member, which in the embodiment shown is a first leg 20, is secured to the body 12. The first leg 20 contacts the string 15 at a first string location (or “contact location”). A second stretching member, which in the embodiment shown is a second leg 24, is fixed to the body 12. The second leg 24 contacts the string 15 at a second string location. A handle 30 is fixed to the body 12. The handle 30 is spaced above the prong 17, such that neighboring strings may be less likely to interfere with movement of the handle 30 during rotation. As the handle 30 is rotated by hand about axis 14, the first leg 20 imparts a lateral force to the string 15 in one direction, while the second leg 24 imparts a force to the string 15 in another direction. Thus, the handle 30 may be torqued to increase tension in the string 15, thereby stretching the string 15. The user can translate the string stretcher 10 to different locations along the string 15 to more thoroughly stretch the string 15.

In the embodiment of FIG. 2, the force imparted by the first leg 20 will typically be opposite (i.e. approximately 180 degrees from) the force imparted by the second leg 24. However, the direction of the forces imparted by legs 20, 24 need not be 180 degrees apart, so long as they are least partially opposing.

With the axis 14 of the string stretcher 10 oriented perpendicular to the fingerboard 62, the legs 20, 24 may move approximately parallel to the fingerboard 62 during rotation. Thus, the string stretcher 10 may avoid contact with the fingerboard 62 during rotation. This is advantageous because fingerboards are often made of expensive woods and have delicate finishes. However, it is not essential that movement of the first and second legs 20, 24 and the forces they generate are parallel to the fingerboard. In some embodiments, for example, those forces and movements may instead be at an angle to the fingerboard 62. For example, the string stretcher 10 may be tilted such that the axis 14 is not perpendicular to the fingerboard 62. In some embodiments, this angle may be up to 45 degrees. In other embodiments, this angle may be greater than 45 degrees.

With further reference to FIG. 2, the handle 30 may be spaced above the prong 17 and above legs 20, 24, as shown. This clearance between the handle 30 and other components of the string stretcher 10 may make the handle 30 easier to grasp. It may also allow the handle 30 to be rotated about the axis 14 without interfering with any of the neighboring strings or the fingerboard 62. Therefore, the prong 17 may be positioned at least one inch from the handle 30. A central body portion 13 may also have a width less than a lateral spacing between the first and second legs 20, 24, providing extra clearance for one's fingers to grasp the handle 30.

Still referring to FIG. 2, the handle 30 may have a longitudinal centerline 32. A “threshold angle” is defined herein as the angle between the longitudinal centerline 32 and the string 15 during threshold contact of the first and second legs 20, 24 with the string 15, i.e. with essentially zero force between the first and second legs 20, 24 and the string 15. In some embodiments, the handle 30 may be substantially parallel to the string 15 under threshold contact, so that the threshold angle is essentially zero. In the FIG. 2 embodiment, the handle centerline 32 is shown at a small angle with respect to the string 15, and the threshold angle is fairly small.

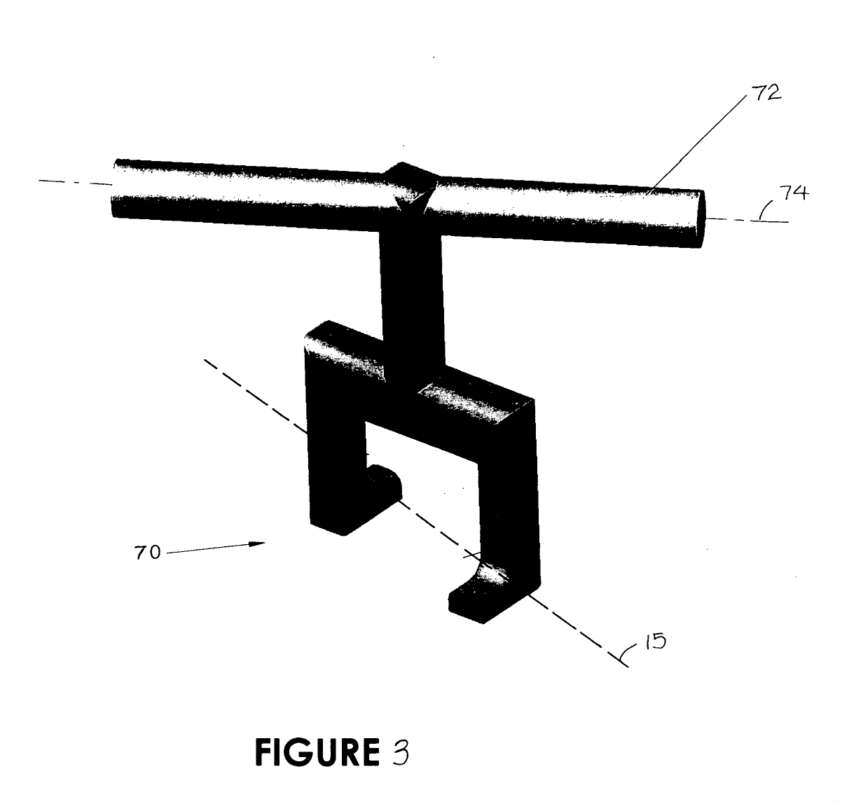

The threshold angle may be selected to provide a number of advantages. For example, it is common to stretch strings with a guitar on one's lap, with the neck 54 generally parallel to one's chest. In this instance, it may be easier to rotate the handle clockwise with the right hand. Thus, it may be ergonomic for the handle to have an acute threshold angle in the counterclockwise direction from the string 15. Furthermore, the threshold angle may be selected to provide a reference indicating a “proper” degree of stretch, such as to prevent the user from over stretching the string. For example, the threshold angle may be selected such that a proper degree of stretch is obtained when the handle is rotated until parallel with the string 15. This provides a visual reference for the user to know how far to rotate the string stretcher 10. In some preferred embodiments, the threshold angle is between 15 and 45 degrees. FIG. 3, for example, illustrates a string stretcher 70 having a handle 72 and a handle centerline 74, wherein the threshold angle is about 30 degrees. Other embodiments may have a threshold angle of between 5 and 85 degrees.

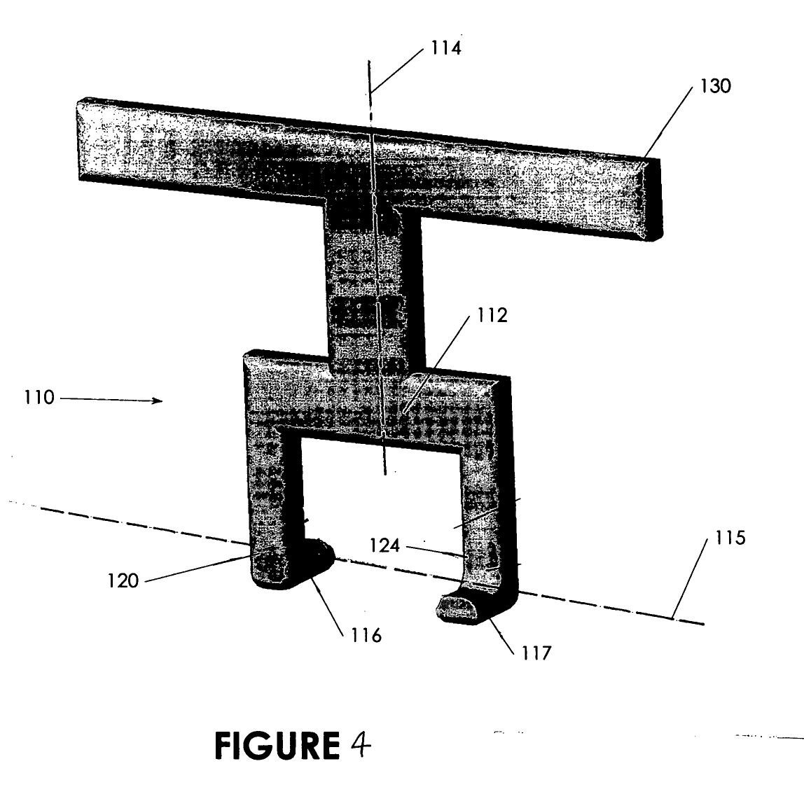

FIG. 4 shows another embodiment of a string stretcher 110. The string stretcher 110 includes first and second prongs 116, 117. The first prong 116 extends from a first leg 120, and the second prong 117 extends from a second leg 124. In other embodiments, the first and second prongs 116, 117 need not extend from the first and second legs 120, 124. A string represented by dashed line 115 is routed over the first and second prongs 116, 117, passing behind the first leg 120 and in front of the second leg 124 (as viewed from the perspective of FIG. 4). The user may pull up slightly on the handle 130 to urge the string 115 upward, to provide clearance about neighboring strings. The user may then use the handle 130 to rotate the string stretcher 110 about the axis of rotation 114. The first leg 120 thereby applies a force to the string 115 in one direction laterally across the fingerboard 62, and the second leg 124 applies a substantially oppositely directed force to the string 115, to stretch the string 115. As with the embodiment of FIG. 2, the user can translate the string stretcher 110 to different locations along the string 115, to more thoroughly stretch the string 115. The first and second legs 120, 124 may be formed of low-friction materials, such as various types of plastic, to allow the string stretcher 110 to be slid along the string 115.

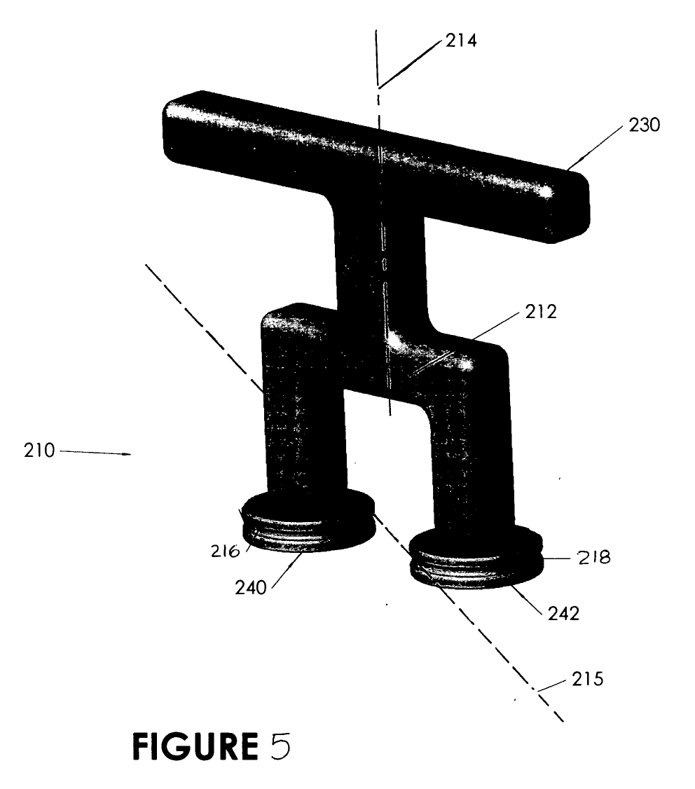

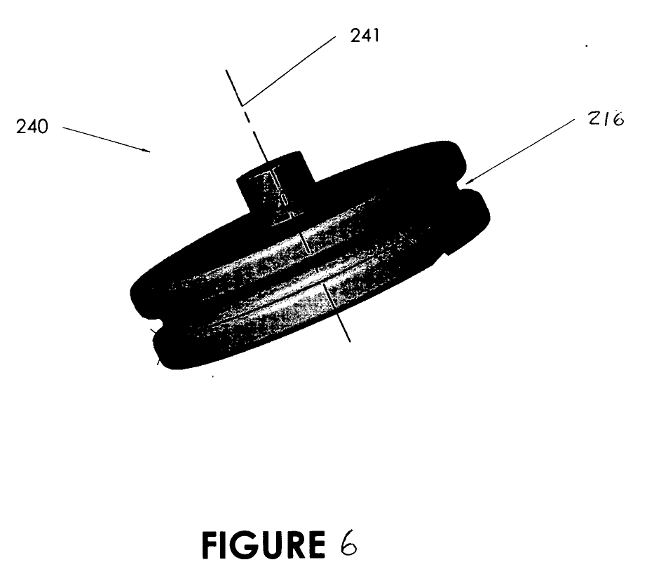

FIG. 5 conceptually shows another embodiment of a string stretcher 210. The string stretcher 210 includes a pair of wheels, which in the embodiment shown may be referred to as pulleys 240, 242 due to their circumferential channels 216, 218. Pulley 240 is further illustrated in FIG. 6 for clarity. The pulley 240 has an axis of rotation 241 oriented substantially parallel to the axis of rotation 214 of the string stretcher 210. The circumferential channel 216 is disposed about the axis 241, providing several advantages. The circumferential channel 216 is adapted for receiving the string 215, which may help position the pulley 240, as well as guide the pulley 240 as it is moved along the string 215. Because the pulleys 240, 242 contact the string and apply opposing forces to the strings, the pulleys 240, 242 may function as stretching members. With the string 215 positioned within the circumferential channel, the string 215 may also be lifted away from the fingerboard 62 by pulling up on the handle 230. Thus, the pulleys 240, 242 may also function as lifting members. Another advantage of the embodiment of FIG. 5 is that the pulleys 240, 242 may roll (rather than slide) along the string 215 while translating the string stretcher 210 along the string. This desirably reduces or eliminates sliding friction between the string stretcher 210 and the string 215, to more easily move the string stretcher 210 along the string 215 and to prevent damage to the string 215.

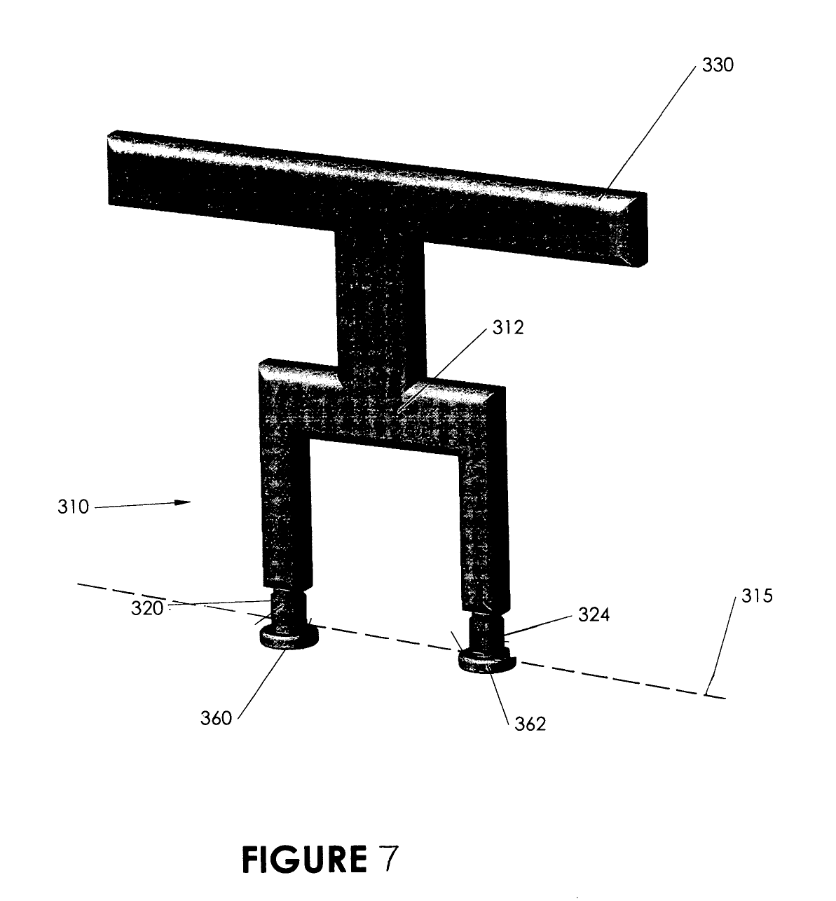

Another embodiment of a string stretcher 310 is illustrated in FIG. 7. The string stretcher 310 has a body 312, and includes a pair of wheels that in this embodiment may be referred to as sleeves 320, 324 due to their sleeve-like shape. The sleeves 320, 324 are free to rotate like wheels. The sleeve 320 may contact the string 315 at one location, and the sleeve 324 may contact the string 315 at another location. Flanges 360 and 362 retain the sleeves 320, 324. Flanges 360, 362 may also engage the string 315 to lift the string 315 upward when the user pulls up on the handle 330. The string stretcher 310 may be rotated by handle 330 to apply opposing lateral forces to stretch the string 315. The string stretcher 310 may also be translated along the string 315, and the sleeves 320, 324 may desirably roll (rather than slide) along the string.

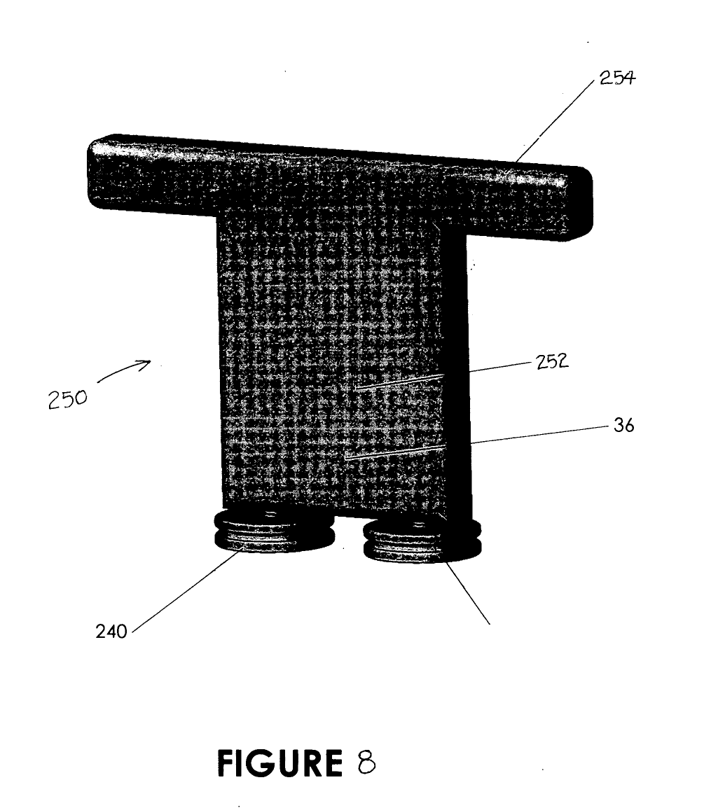

Although embodiments discussed include legs, it is conceivable to construct a string stretcher with essentially no legs. FIG. 8, for example, illustrates a “legless” string stretcher 250 having a body 252, to which a handle 254 and the pulleys 240, 242 are secured. An advantage of the legless string stretcher 250 is a potentially increased torsional stiffness, to resist flexing of the string stretcher 250 during stretching.

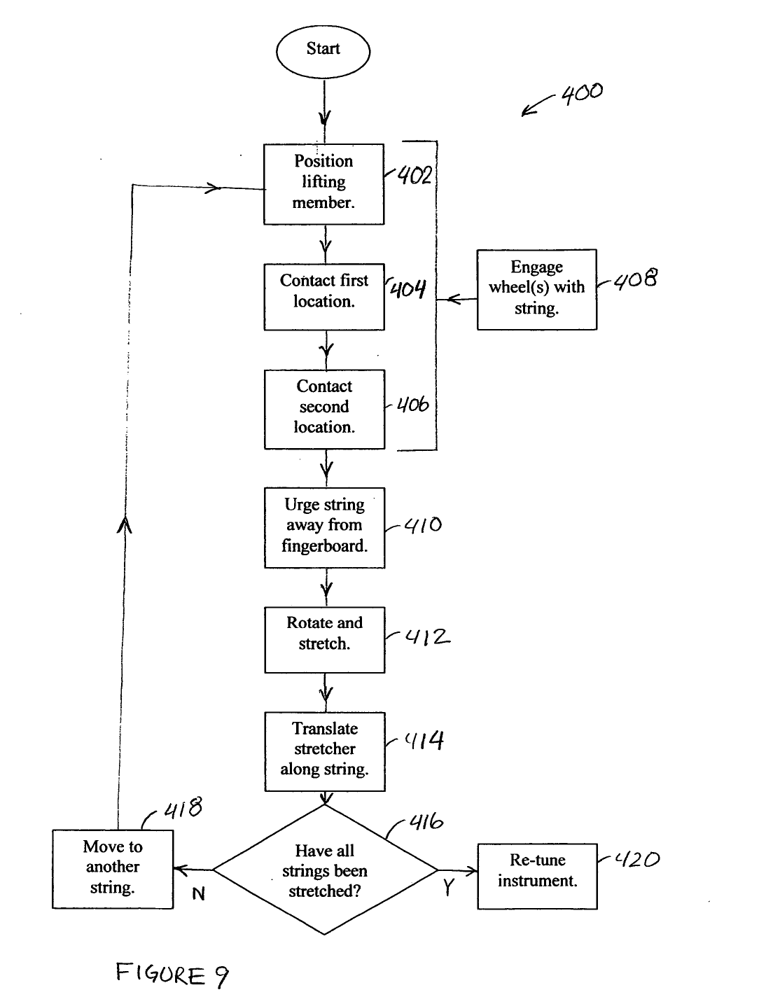

FIG. 9 is a flowchart 400 illustrating an embodiment of a method for stretching the strings of a stringed instrument. In step 402, a lifting member coupled to a body is positioned between one of the strings and a fingerboard of the musical instrument. In step 404, the string is contacted at a first location with a first member. In step 406, the string is contacted at a second location with a second member. In step 408, one or more wheels are optionally engaged with the string, which may simultaneously satisfy one or more of steps 402, 404, and 406. In step 410, the string stretcher is lifted upwardly to urge the string at least slightly away from the fingerboard, to provide clearance about neighboring strings. In step 412, the body is rotated by hand, such as by using a handle secured to the body, to stretch the string. In step 414, the body is moved to translate the first and second members along the string. Step 414 may be performed concurrently with step 412. In step 416, the decision is made whether to stretch other strings. Generally, it is best to stretch all the strings, so step 418 directs the user to move to another string and repeat steps 402-414 until all the strings have been stretched. The strings will typically go flat during stretching. Thus, after all the strings have been stretched it is appropriate to re-tune the instrument, as indicated in step 420.

Embodiments of a string stretcher may be configured for rotation by hand. As discussed in connection with some embodiments, a string stretcher may include a handle for rotating the body. This represents a potentially economical way to form a string stretcher. Other embodiments may be alternately configured for rotation by hand in other ways. For example, one can conceive a pair of grips, such as those on a pair of pliers, wherein the grips operate the first and second members through a series of linkages and so forth. For instance, squeezing the grips by hand may drive rotation of the body. In other embodiments, a powered mechanism may be included for rotating the body. For example, pressing a button or moving a lever may actuate a motor to power rotation of the body. In still other embodiments, the first and second members may be configured to apply opposing lateral forces to the strings without specifically requiring rotation of a body.

The various embodiments provide a number of advantages, many of which are discussed above. One advantage is that a user may stretch the strings of an instrument without the discomfort of stretching them between the user's fingers. Embodiments of a string stretcher may be manufactured fairly inexpensively, such as by injection molding plastic. The string stretcher may have a limited number of parts, to further minimize cost. Thus, the device may be affordable to virtually all musicians, who typically come from all walks of life, and many of whom are on a budget. The string stretcher may be compact, and thus easy to carry around in a guitar case, along with other typical accessories such as peg winders, guitar picks, capos, and so forth. In fact, some embodiments may comprise multi-function tools, such as a combination peg winder and string stretcher. The user may move a string stretcher along the string while applying a stretching force, to more uniformly stretch a string, which would be painful or impossible using bare fingers. Embodiments having wheels may allow the string stretcher to roll along the string, minimizing effort, and minimizing wear and tear to the string. Other advantages will be apparent to those skilled in the art.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

1. A string stretcher, comprising:
a body;
a first member coupled to the body and adapted for contacting a string of a musical instrument at a first contact location;
a second member coupled to the body and adapted for contacting the string at a second contact location spaced from the first contact location; and
wherein the body is configured for rotation by hand such that the first member applies a force to the string in one direction while the second member applies a force to the string in another direction.

2. The string stretcher of claim 1, wherein the one direction is substantially opposite the another direction.

3. The string stretcher of claim 1, wherein the one direction and the another direction are each less than about 45 degrees from parallel to a fingerboard of the musical instrument.

4. The string stretcher of claim 1, wherein the one direction and the another direction are each substantially parallel to a fingerboard of the musical instrument.

5. The string stretcher of claim 1, wherein the first member comprises a first leg and the second member comprises a second leg.

6. The string stretcher of claim 5, wherein the first leg is substantially parallel to the second leg.

7. The string stretcher of claim 1, wherein the first member comprises a wheel adapted for contacting the string at the first location.

8. The string stretcher of claim 7, wherein the second member comprises another wheel adapted for contacting the string at the second location.

9. The string stretcher of claim 7, wherein the wheel comprises a circumferential channel adapted for receiving the string.

10. The string stretcher of claim 1, further comprising a handle disposed on the body.

11. The string stretcher of claim 10, wherein the handle has a longitudinal centerline angled between 5 and 85 degrees with respect to a line defined by the first and second contact locations.

12. The string stretcher of claim 11, wherein the longitudinal centerline of the handle is substantially perpendicular to an axis of rotation.

13. The string stretcher of claim 1, further comprising a lifting member disposed on the body, the lifting member adapted for urging the string at least slightly away from a fingerboard.

14. The string stretcher of claim 13, wherein the lifting member contacts the string at a third contact location spaced from the first and second contact locations.

15. The string stretcher of claim 13, wherein the lifting member comprises at least one prong adapted for positioning between the string and a fingerboard.

16. The string stretcher of claim 15, wherein the at least one prong is disposed on at least one of the first and second members.

17. A method of stretching a string of a stringed instrument, comprising:
contacting the string at a first location with a first member coupled to a body;
contacting the string at a second location with a second member coupled to the body; and
rotating the body, such that the first member applies a force to the string in one direction while the second member applies a force to the string in another direction.

18. The method of claim 17, further comprising:
positioning a lifting member between the string and a fingerboard; and
urging the string at least slightly away from the fingerboard at a contact location between the lifting member and the string.

19. The method of claim 17, further comprising moving the first and second members along the string.

20. The method of claim 19, further comprising engaging a wheel with the string such that the wheel rotates during movement of the first and second members along the string.
